(19) United States
(12) Patent Application Publication
(10) Pub. No.: US 2026/0051676 A1
(43) Pub. Date: Feb. 19, 2026

(54) MEMORY MODULE CONNECTOR

(71) Applicant: JPC connectivity Inc., New Taipei City (TW)

(72) Inventor: Wen-Lung HSU, New Taipei City (TW)

(21) Appl. No.: 18/948,445

(22) Filed: Nov. 14, 2024

(30) Foreign Application Priority Data
Aug. 15, 2024 (TW) 113130748

(51) Int. Cl. H01R 12/71; H01R 12/70; H01R 13/24

(52) U.S. Cl. CPC H01R 12/712; H01R 12/7047; H01R 13/2464

(57) ABSTRACT

This disclosure is directed to a memory module connector having a circuit board, an insulative plate and a plurality of terminals. The circuit board has a circuit. The insulative plate has a first surface and a second surface. The insulative plate is attached on the circuit board via the first surface. The insulative plate has a plurality of through openings connected to the first surface and the second surface respectively. The terminals are respectively arranged in the through openings. Each terminal is defined with a thickness direction. Each terminal has an elastic arc arm extended along a plane perpendicular to the thickness direction of the terminal. The terminals are arranged parallel to each other. Each terminal is exposed from the through slot at two ends of the opening. Each terminal has one end in contact with the circuit and the other end exposed on the second surface.

### BACKGROUND OF THE INVENTION

### TECHNICAL FIELD

This disclosure is directed to a memory module, in particular to a memory module connector, and in particular to a memory module connector having structural improved terminals.

### DESCRIPTION OF RELATED ART

CAMM2 is fully named “Compression Attached Memory Module Gen 2.”, "CAMM" was firstly provided by Dell in 2022 and promoted to the JEDEC Association. Compressible terminals are applied in CAMM2 to improve the reliability of the connector via a and shorten signal transmission distance in the connector, thereby accelerating signal transmission. CAMM2 also supports a memory capacity up to 128 GB, and heat dissipation of the memory module may be improved via the structural configuration of CAMM2.

Commonly used compressible terminals are made by bending straight metal sheets which are formed by punching (forming type). However, the punching process should be applied to a plat with uniform thickness, and a thickness at a root of each elastic arm should be equal to a thickness of the punched material. If a wider root is disposed for causing a higher structural strength, the overall width of the terminal would be increased. This results in a narrower interval between two adjacent terminals, and further results in a stronger interfere to the signal transferred in the two adjacent terminals and a lower signal integrity.

Accordingly, the electrical characteristics and structural strength of the compressible terminal of related art are limited by the manufacturing process and therefor difficult to be improved.

In views of this, in order to solve the above disadvantage, the inventor studied related technology and provided a reasonable and effective solution in this disclosure.

### SUMMARY OF THE INVENTION

This disclosure is directed to a memory module connector, and in particular to a memory module connector having structural improved terminals.

This disclosure is directed to a memory module connector used for docking a memory module. The memory module connector has a circuit board, an insulative plate and a plurality of terminals. The circuit board has a docking surface, and a circuit is disposed on the docking surface. The insulative plate has a first surface and a second surface opposite to each other, the insulative plate is attached on the docking surface, and the first surface is attached on the docking surface. The insulative plate has a plurality of through slots, and each of the through slots is connected between the first surface and the second surface. The terminals are respectively inserted in the through slots, each of the terminals is a planar body and defined with a thickness direction, each of the terminals has an elastic arc arm, and the elastic arc arm is extended along a plane perpendicular to the thickness direction of the terminal, the thickness directions of the terminals are parallel to each other and the terminals are disposed in a matrix manner, each of the terminals are exposed from two ends of the through slot corresponding thereto, each of the terminals has a first end and a second end. In each of the terminals, the first end abuts against the circuit and the second end is exposed from the second surface. The memory module is abutted by the second end of each of the terminals when docked with the memory module, and each of the elastic arc arms is compressed between the circuit board and the memory module to make the first end contact with the second end in each of the terminal.

According to one embodiment of this disclosure, in each of the terminals, the terminal has a pair of actuating bars, the pair of actuating bars are disposed at two ends of the elastic arc arms respectively, each of the actuating bars has an outer end and an inner end, two of the inner ends on two of the actuating bars face each other, the outer end on one of the actuating bars abuts against the circuit, and the outer end on another of the actuating bars is exposed from the second surface.

According to one embodiment of this disclosure, in each of the terminals, when the elastic arc arm is compressed between the circuit board and the memory module, two inner ends of the two actuating bars contact with each other.

According to one embodiment of this disclosure, in each of the terminals, the terminal has a first latch, the first latch protrudes from one surface of the terminal along the thickness direction of the terminal, and the first latch snaps on an internal surface of the through slot corresponding thereto.

According to one embodiment of this disclosure, in each of the terminals, the first latch is defined on the terminal by punching, a first through opening corresponding to the first latch is defined on the terminal, and the first latch has a root portion connected to an inner edge of the first through opening.

According to one embodiment of this disclosure, in each of the terminals, the terminal has a stopper portion, the stopper portion protrudes from one surface of the terminal along the thickness direction of the terminal. A plurality of stopper slots corresponding to the through slots are arranged on the first surface of the insulative plate, each of the stopper slots is communicate with one side of the through slot corresponding thereto, and each of the stopper portions is inserted in the stopper slot correspondingly.

According to one embodiment of this disclosure, in each of the terminals, the stopper portion is extended from a portion of a periphery of the terminal, and the stopper portion is bent to be parallel to the thickness direction of the terminal.

According to one embodiment of this disclosure, in each of the terminals, the terminal has a second latch, the second latch protrudes from one side of the stopper portion, and the second latch snaps on an internal surface of the stopper slot correspondingly.

According to one embodiment of this disclosure, in each of the terminals, the second latch is defined on the terminal by punching, a second through opening corresponding to the second latch is defined on the terminal, and the second latch has a root portion connected to an inner edge of the second through opening.

According to one embodiment of this disclosure, an interval defined between two of the terminals adjacent to each other is 10 times greater than the thickness of each terminal.

According to this disclosure, the memory module connector has terminals defined with wider intervals related to the thickness of the terminal between two of the terminals adjacent to each other may be related to the thickness of the terminal, this leads to a lower interfere to the signal transferred in the two adjacent terminals and an improved signal integrity.

In order to withstand the compression force without increasing an overall width of the terminal, wider terminals may be disposed corresponding to various requirements of compression, so as to provide a greater structural strength.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is an exploded view showing a memory module connector and a memory module according to one embodiment of this disclosure.

FIG. 2 is an exploded view showing the memory module connector according to the embodiment of this disclosure mentioned above.

FIG. 3 is a perspective view showing terminals of the memory module connector according to the embodiment of this disclosure mentioned above.

FIG. 4 is another perspective view showing the terminals of the memory module connector according to the embodiment of this disclosure mentioned above.

FIG. 5 is an enlarged view showing the terminals of the memory module connector according to the embodiment of this disclosure mentioned above.

FIG. 6 is another enlarged view showing the terminals of the memory module connector according to the embodiment of this disclosure mentioned above.

FIG. 7 is a cross-sectional view at cross line 7-7 as shown in FIG. 6.

FIG. 8 is a cross-sectional view at cross line 8-8 as shown in FIG. 6.

FIG. 9 is a cross-sectional view at cross line 9-9 as shown in FIG. 6.

FIG. 10 is a cross-sectional view at cross line 10-10 as shown in FIG. 6.

FIG. 11 is a cross-sectional view illustrating the terminals in a status that the memory module connector is docked with the memory module.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

It should be understood that the orientations or positional relationships in this disclosure which are indicated by the terms such as “front side”, “rear side”, “left side”, “right side”, “front end”, “rear end”, “end”, “vertical”, “horizontal”, “vertical”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Detailed descriptions and technical contents of this disclosure is described in the flowing paragraph with reference to the drawings. However, the drawings are attached only for illustration and are not intended to limit this disclosure.

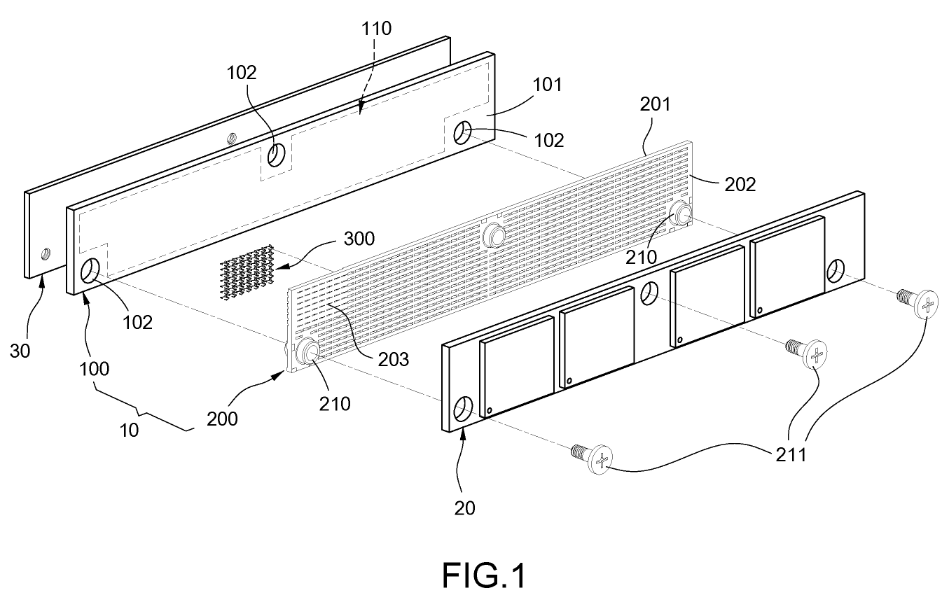

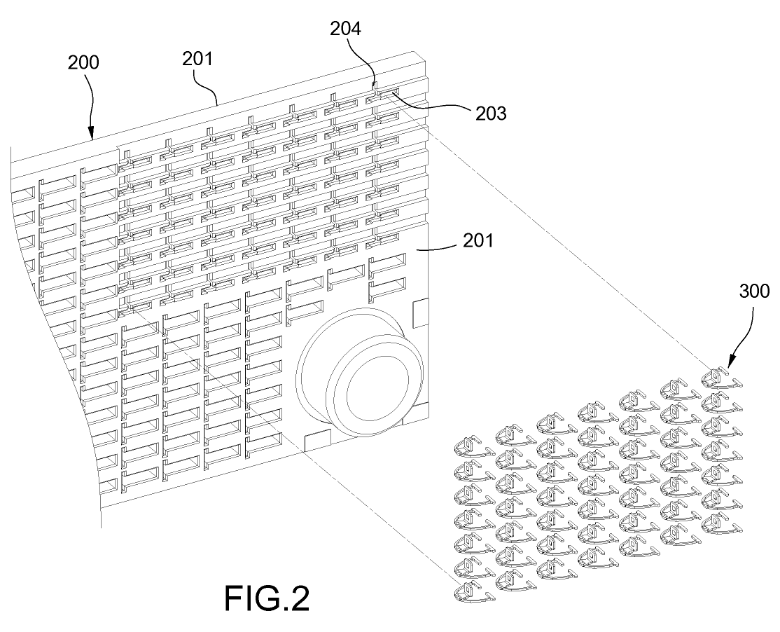

FIG. 1 is an exploded view showing a memory module connector 10 and a memory module 20 according to one embodiment of this disclosure. FIG. 2 is an exploded view showing the memory module connector 10 according to the embodiment of this disclosure mentioned above. Refiring FIGS. 1 and 2, a memory module connector 10 used for docking a memory module 20 is provided in one embodiment of this disclosure. According to this embodiment, the memory module connector 10 has a circuit board 100, an insulative plate 200 and a plurality of terminals 300.

Referring to FIG. 1, the circuit board 100 has a docking surface 101, a circuit 110 is disposed on the docking surface 101, and the circuit board 100 has at least one fastening hole 102, one example of the circuit board 100 has fastening holes 102 three according to this embodiment, but the number should not be limited to the embodiment mentioned above. Specifically, each of the fastening holes 102 penetrates the circuit board 100.

The insulative plate 200 has a first surface 201 and a second surface 202 opposite to each other, the insulative plate 200 is attached on the docking surface 101, and the first surface 201 is attached on the docking surface 101. The insulative plate 200 has a plurality of through slots 203, each of the through slots 203 is connected between the first surface 201 and the second surface 202. At least one sleeve 210 is disposed on the insulative plate 200 corresponding to the fastening hole(s) 102 on the circuit board 100. According to this embodiment, three sleeves 210 are disposed on the insulative plate 200 corresponding to the three fastening holes 102 on the circuit board 100, but the scopes of this disclosure should not be limited to the embodiment mentioned above. Specifically, each of the sleeves 210 penetrates the insulative plate 200.

The circuit board 100 and the insulative plate 200 as disposed in a stack attached on the base 30. Specifically, a fastening screw 211 is inserted in each of the sleeves 210 on the insulative plate 200, each of the fastening screws 211 correspondingly penetrates the fastening hole 102 on the circuit board 100 to screw the base 30, so that the memory module connector 10 of this disclosure is fixed on the base 30. The base 30 is a structure at a position where the memory module connector 10 is disposed, and may be a part of an electronic device. When the memory module 20 is docked to the memory module connector 10, each of the fastening screws 211 further penetrates the memory module 20 to screw the memory module 20 onto the memory module connector 10.

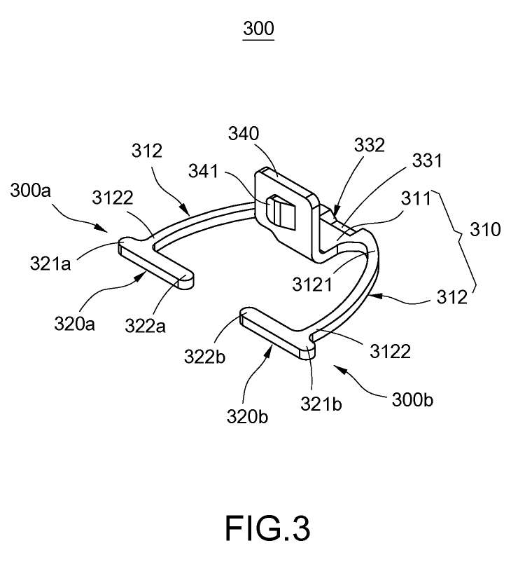

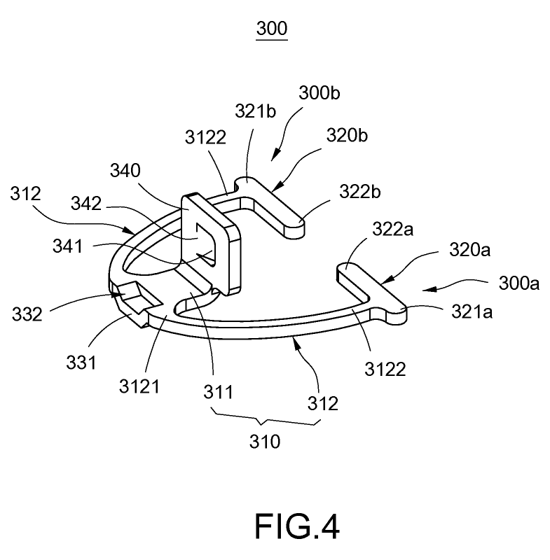

FIG. 3 is a perspective view showing terminals of the memory module connector according to the embodiment of this disclosure mentioned above. FIG. 4 is another perspective view showing the terminals of the memory module connector according to the embodiment of this disclosure mentioned above.

Referring to FIGS. 3 and 4, each of the terminals 300 is made by punching (blanking type or forming type) so that each of the terminals 300 is a planar body and defined with a thickness direction 301, a first end 300a and a second end 300b. In each of the terminals 300, the terminal 300 has an elastic arc arm 310, and the elastic arc arm 310 is extended to the first end 300a and the second end 300b along a plane perpendicular to the thickness direction 301 of the terminal 300.

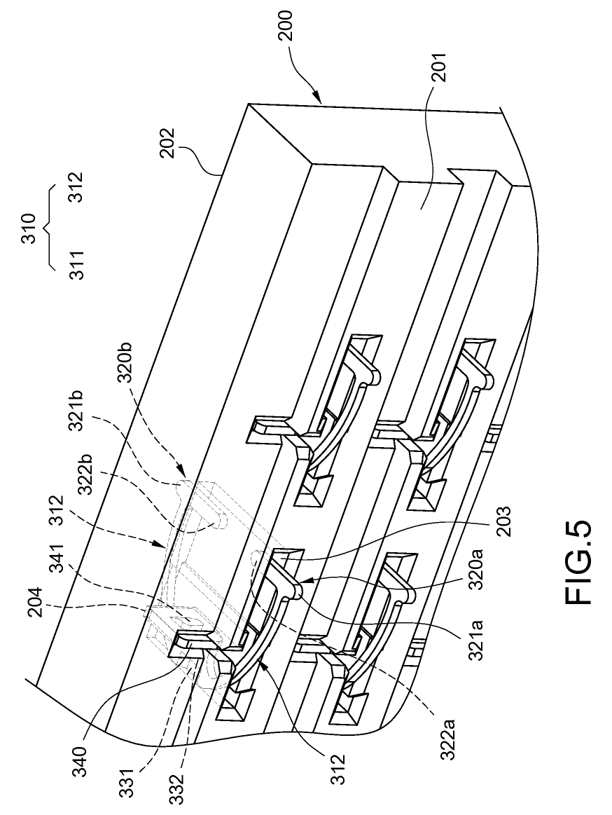

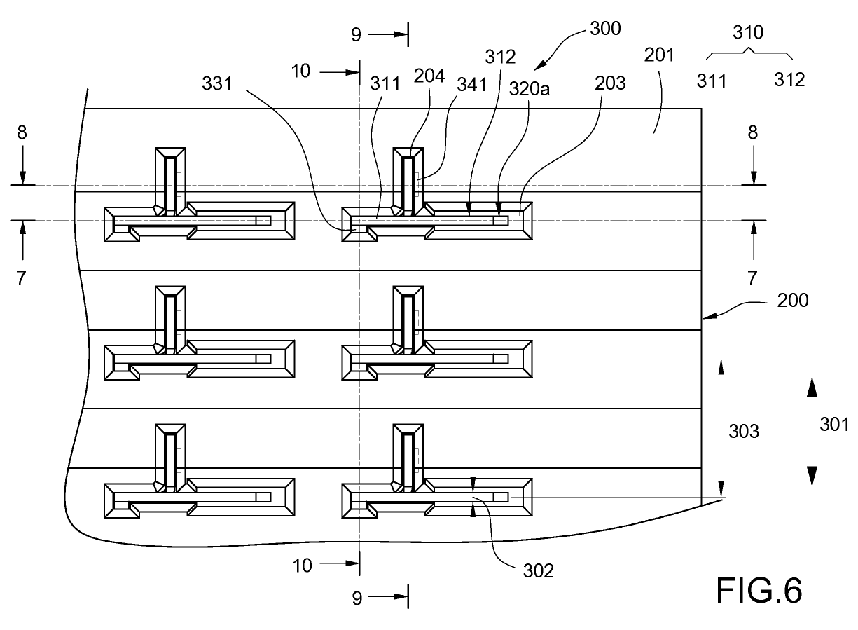

FIG. 5 is an enlarged view showing the terminals of the memory module connector according to the embodiment of this disclosure mentioned above. FIG. 6 is another enlarged view showing the terminals of the memory module connector according to the embodiment of this disclosure mentioned above. Referring to FIGS. 5 and 6, the terminals 300 are respectively inserted in the through slots 203, and the terminals 300 are parallel to each other and disposed in lines along the thickness directions 301 of the terminals 300, respectively. Each of the terminals 300 is exposed at two ends of the through slot 203 corresponding thereto.

Referring to FIGS. 3 and 4, in each of the terminals 300, a pair of actuating bars 320a, 320b are respectively provided the terminal 300 first end 300a and the second end 300b, the pair of actuating bars 320a, 320b are disposed at two ends of the elastic arc arm 310. Each of the actuating bars 320a, 320b has an outer end 321a, 321b and an inner end 322a, 322b, two of the inner ends 322a, 322b on two of the actuating bar 320a, 320b are facing each other. Specifically, the elastic arc arm 310 has a fixed portion 311 and a pair of arm portions 312 respectively extended from two opposite side of the fixed portion 311, each of the arm portions 312 has a root end 3122 connected to the fixed portion 311 and a distal end 3121 opposite to the root end 3122, the actuating bars 320a, 320b are respectively disposed at the distal ends 3121.

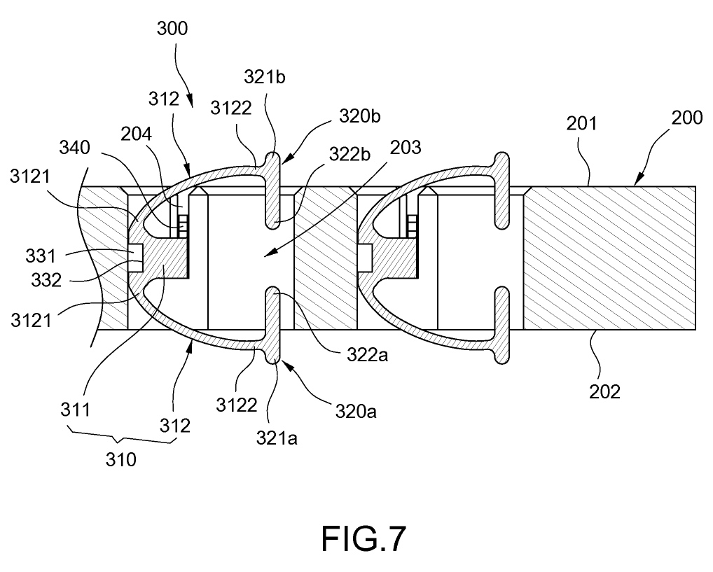

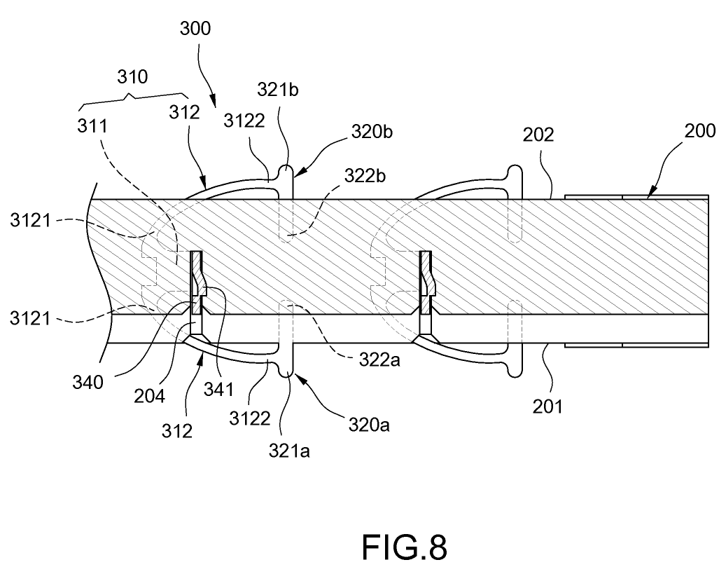

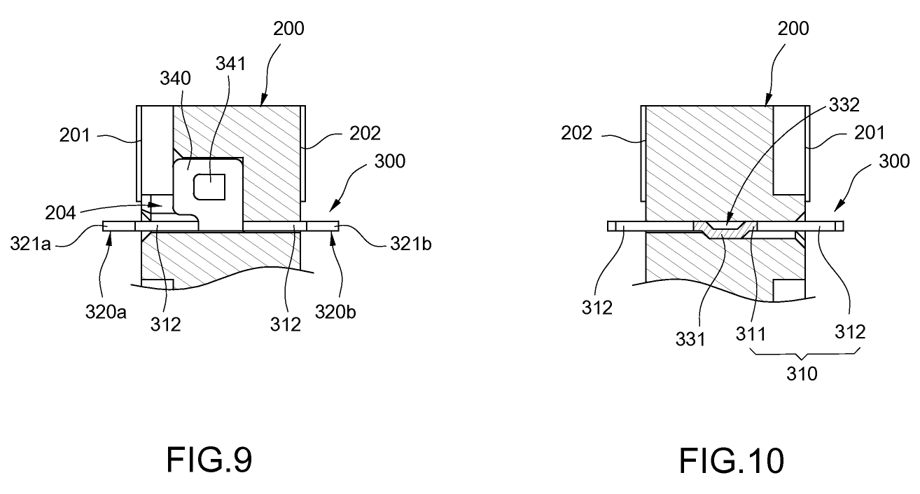

Referring to FIGS. 3 to 6, in each of the terminals 300, the terminal 300 has a stopper portion 340, the stopper portion 340 protrudes from one surface of the terminal 300 along the thickness direction 301 of the terminal 300. Referring to FIGS. 6 to 9, a plurality of stopper slots 204 corresponding to the through slots 203 are disposed on the first surface 201 of the insulative plate 200, each of the stopper slots 204 is communicated with one side of the through slot 203 correspondingly, and each of the stopper portions 340 is inserted in the stopper slot 204 correspondingly. The stopper portion 340 is extended from a portion of a periphery of the terminal 300, and the stopper portion 340 is bent to be parallel to the thickness direction 301 of the terminal 300.

Referring to FIGS. 3, 4, 8 and 10, in each of the terminals 300, the terminal 300 has at least one latch. As shown in this embodiment, the terminal 300 is provided with two latches which are a first latch 331 and a second latch 341, but the latch should not be limited to the number recited in the embodiment mentioned above. The first latch 331 protrudes from one surface of the terminal 300 along the thickness direction 301 of the terminal, and the first latch 331 snaps on an internal surface of the through slot 203 correspondingly. The first latch 331 is defined on the terminal 300 by punching, a first through opening 332 corresponding to the first latch 331 is defined on the terminal 300, and the first latch 331 has a root portion connected to an inner edge of the first through opening 332. Further referring to FIGS. 3, 4 and 8, the second latch 341 protrudes from one side of the stopper portion 340, and the second latch 341 snaps on an internal surface of the stopper slot 204 correspondingly. The second latch 341 is defined on the terminal 300 by punching, a second through opening 342 corresponding to the second latch 341 is defined on the terminal 300, and the second latch 341 has a root portion connected to an inner edge of the second through opening 342.

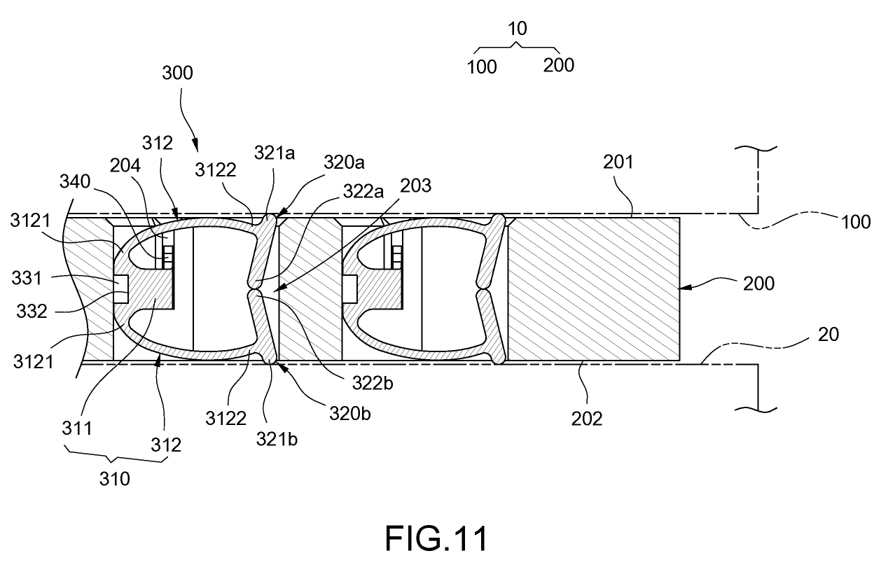

FIG. 11 is a cross-sectional view illustrating the terminals 300 in a status that the memory module connector 10 is docked with the memory module 20. Referring to FIGS. 3, 4, 8 and 11, in each of the terminals 300, the terminal 300 has one end abutting against the circuit 110 on the circuit board 100 to be electrically connect with the circuit board 100, and the terminal 300 has another end exposed from the second surface 202 for docking the memory module 20. Specifically, the outer end 321a on one of the actuating bars 320a is exposed from the first surface 201 to abut against the circuit 110, and the outer end 321b on another of the actuating bars 320b is exposed from the second surface 202. When docked with the memory module 20, the memory module 20 is attached on the second surface 202, so that the elastic arc arm 310 is compressed between the circuit board 100 and the memory module 20, and two of the ends on each of the terminals 300 are contacted with teach other. When the elastic arc arm 310 is compressed between the circuit board 100 and the memory module 20, two of the inner ends 322a, 322b on two of the actuating bars 320a, 320b are contacted with each other. Signals may pass through the shortest path formed by two of the actuating bars 320a, 320b instead of through the entire elastic arc arm 310, thereby reducing the signal transmission impedance and improving characteristics of the signal in high-frequency.

According to FIG. 6, the terminal 300 has a thickness 302 within 0.05 mm to 0.1 mm, an interval 303 defined between two of the terminals 300 adjacent to each other is 10 times greater than the thickness of each terminal 300. According to, the terminal 300 has a thickness 302 of 0.06 mm, and an interval 303 defined between two of the terminals 300 adjacent to each other is 0.87 mm, but the scopes of this disclosure should not be limited to this. Accordingly, the interval 303 defined between two of the terminals 300 adjacent to each other may be wider related to the thickness 302 of the terminal 300, this leads to a lower interfere to the signal transferred in the two adjacent terminals 300 and an improved signal integrity.

Referring to FIGS. 3, 4, 7 and 11, when the terminal 300 is compressed, compressive stress concentrations are located on the arm portions 312 at the root ends 3122 thereof. In each of the terminals 300 according to the memory module connector 10 of this disclosure, in order to withstand the compression force without increasing an overall width of the terminal 300, the root end 3122 of each arm portion 312 may be formed wider corresponding to various requirements of the elastic arc arm 310 to provide a greater structural strength and prevent the elastic arc arm 310 from fracture caused by compressing.

While this disclosure has been described by means of specific embodiments, numerous modifications and variations could be made thereto by those skilled in the art without departing from the scope and spirit of this disclosure set forth in the claims.

What is claimed is:

1. A memory module connector, used for docking a memory module, the memory module connector comprising:
a circuit board, comprising a docking surface and a circuit disposed on the docking surface;
an insulative plate, comprising a first surface and a second surface disposed opposite to each other, and attached on the docking surface, wherein the first surface is attached on the docking surface, the insulative plate comprises a plurality of through slots, the through slots are respectively connected between the first surface and the second surface; and
a plurality of terminals, respectively arranged in the through slots, wherein each of the terminals is a planar body and defined with a thickness direction, each of the terminals comprises an elastic arc arm extended along a plane perpendicular to the thickness direction of the terminal, a plurality of the thickness directions of the terminals are parallel to each other, the terminals are disposed in a matrix manner, each of the terminals is exposed from two ends of the through slot correspondingly, each of the terminals comprises a first end and a second end, the first end of each of the terminals abuts against the circuit and the second end of each of the terminals is exposed from the second surface, when the memory module is docked, the memory module abuts against the second end of each of the terminals, the elastic arc arm is compressed between the circuit board and the memory module to make the first end contact with the second end in each of the terminals.

2. The memory module connector according to claim 1, wherein, in each of the terminals, the terminal comprises a pair of actuating bars, the pair of actuating bars is disposed at two ends of the elastic arc arm respectively, each of the actuating bars comprises an outer end and an inner end, two inner ends of the two actuating bars faces each other, the outer end of one of the two actuating bars abuts against the circuit, and the outer end of another one of the two actuating bars is exposed from the second surface.

3. The memory module connector according to claim 2, wherein, in each of the terminals, when the elastic arc arm is compressed between the circuit board and the memory module, two inner ends of the two actuating bars contact with each other.

4. The memory module connector according to claim 1, wherein, in each of the terminals, the terminal comprises a first latch, the first latch protrudes from one surface of the terminal along the thickness direction of the terminal, and the first latch snaps on an internal surface of the through slot correspondingly.

5. The memory module connector according to claim 4, wherein, in each of the terminals, the first latch is defined on the terminal by punching, a first through opening corresponding to the first latch is defined on the terminal, and the first latch comprises a root portion connected to an inner edge of the first through opening.

6. The memory module connector according to claim 1, wherein, in each of the terminals, the terminal comprises a stopper portion, the stopper portion protrudes from one surface of the terminal along the thickness direction of the terminal,
wherein a plurality of stopper slots corresponding to the through slots are defined on the first surface of the insulative plate, each of the stopper slots communicates with one side of the through slot correspondingly, and each of the stopper portions is inserted in the stopper slot correspondingly.

7. The memory module connector according to claim 6, wherein, in each of the terminals, the stopper portion is extended from a portion of a periphery of the terminal, and the stopper portion is bent to be parallel to the thickness direction of the terminal.

8. The memory module connector according to claim 6, wherein, in each of the terminals, the terminal comprises a second latch, the second latch protrudes from one side of the stopper portion, and the second latch snaps on an internal surface of the stopper slot correspondingly.

9. The memory module connector according to claim 8, wherein, in each of the terminals, the second latch is defined on the terminal by punching, a second through opening corresponding to the second latch is defined on the terminal, and the second latch comprises a root portion connected to an inner edge of the second through opening.

10. The memory module connector according to claim 1, wherein an interval defined between two of the terminals adjacent to each other is 10 times greater than a thickness of each terminal.
